(19) United States
(12) Patent Application Publication
(10) Pub. No.: US 2011/0154617 A1
(43) Pub. Date: Jun. 30, 2011

(54) DOOR HANDLE APPARATUS

(75) Inventors: Ryoichi Tanaka, Kanagawa (JP); Noriaki Itou, Kanagawa (JP)

(73) Assignee: ALPHA CORPORATION, Yokohama-shi (JP)

(21) Appl. No.: 13/061,070

(22) PCT Filed: Nov. 2, 2009
(86) PCT No.: PCT/JP2009/068783

§ 371 Date: Feb. 25, 2011

(30) Foreign Application Priority Data
Nov. 4, 2008 (JP) 2008-283092

(51) Int. Cl. E05B 1/00

(52) U.S. Cl. 16/412

(57) ABSTRACT

A door handle apparatus is provided with: a handle base (6); an operation handle (3) rotatably connected to the handle base (6) via a rotating shaft (4) and including a handle portion (1) on which a button insertion opening (2) is opened; a switch mounting hole (7) opened in the handle base (6); a push button switch (10) inserted from a back side opening portion of the switch mounting hole (7) and including an operation button portion (8) exposed from a front side opening portion of the switch mounting hole (7); a retaining step portion (9) formed within the switch mounting hole (7) and adapted to prevent the pushbutton switch (10) from dislocating in a front direction; and a stopper (13) including a shaft locking piece (11) engaging with the rotating shaft (4) to restrict a dislocation of the rotating shaft, and a stopper piece (12) for restricting a dislocation of the push button switch (10) in a back direction.

### TECHNICAL FIELD

The present invention relates to a door handle apparatus.

### BACKGROUND ART

A door handle apparatus described Patent Document 1 is known as a door handle apparatus in which an operation button is exposed from a handle portion of an operation handle. In this prior art example, the door handle apparatus is made so that an operation handle is rotatably connected to a support portion which is formed by cutting a door panel to be erected by use of handle shafts (rotating shafts).

A switch portion (a push button switch) is mounted on the door panel. The switch portion is pushed into a locking hole from a front surface side of a door to be fixed in place therein and a button portion is exposed from a cutout-like recess portion (a button insertion opening) which is opened in the operation handle.

In this prior art example, however, since the operation handle is directly assembled on to the door panel, there is caused a problem that the vehicle assembling efficiency is reduced.

This problem can be solved by a door handle apparatus described in Patent Document 2 in which a sub-assembly member is made by connecting an operation handle rotatably to a holder (a handle base) via supporting shafts (rotating shafts) and fixing a push button switch to the handle base. However, as this occurs, since in fabricating the sub-assembly member, fixing operations of the rotating shaft and the push button, switch are necessary, there is caused a problem that the assembling efficiency is not good.

[Patent Document 1] US 2008/0250607

[Patent Document 2] JP-A-2005-330752

### SUMMARY OF INVENTION

One or more embodiments of the invention provide a door handle apparatus which can not only reduce the number of man-hours required to mount the door handle apparatus on a door but also provide good components assembling properties.

In accordance with one or more embodiments of the invention, a door handle apparatus is formed by supporting pivotally an operation handle 3 on a handle base 6 by use of rotating shafts 4. A push button switch 10 is fixed to the handle base 6 for operating an electronic locking and unlocking device, for example, and as a matter of convenience in operating the push button 10, an operation button portion 8 is exposed from a handle portion 1 of the operation handle 3.

The push button switch 10 is mounted by inserting the push button switch 10 into a switch mounting hole 7 which is opened in the handle base 6 in a front direction from a back side opening portion of the switch mounting hole 7. (In this description, based on a condition in which the door handle apparatus is mounted on a door 5, a vehicle width direction is defined as denoting “front, rear (back),” a vehicle length direction is defined as denoting “left, right” and a vehicle height direction is defined as denoting “upwards, downwards.”) By the push button switch 10 being inserted from the back side of the switch mounting hole 7, the exposure of a fixing portion to a front wall surface which is likely to become visible to the eyes of the user as when the operation handle 3 is operated can be prevented, thereby making it possible to improve the external appearance of the door handle apparatus aesthetically.

In such a state that the push button switch 10 is inserted in the switch mounting hole 7, a dislocation of the pushbutton switch 10 to a front side is restricted by a retaining step portion 9 formed in the switch mounting hole 7, and a dislocation of the push button switch 10 to a back side is restricted by a stopper 13 which is locked on rotating shafts 4 by shaft locking pieces 11. The shaft locking piece 11 locks on the rotating shaft to restrict a movement of the rotating shaft 4 in a direction in which the rotating shaft 4 is dislocated. Thus, the shaft locking piece 11 functions to prevent the dislocation of the rotating shaft 4, and the stopper 13 can be used to restrict the dislocation of the push button switch 10. Thus, since the two operations can be completed at one time only by performing the mounting operation of the stopper 13, the assembling performance is improved.

The stopper 13 can be mounted on the rotating shafts 4 using an appropriate means. For example, the operation handle 3 is pivotally supported so as to permit idle rotation, and the shaft locking pieces 11 are connected to the rotating shafts 4 which are not allowed to rotate idly relative to the handle base 6 so as not to rotate idly by holders or snap rings. By forming the stopper piece 12 to lie in a position where the stopper piece 12 closes the back side opening portion of the switch mounting hole 7 with the stopper 13 mounted on the rotating shafts 4, an abrupt dislocation of the push button switch 10 can be prevented in an ensured fashion before the bush button switch 10 is assembled on to the door 5.

The prevention of dislocation of the rotating shafts 4 by the mounting of the stopper 13 can be attained by forming stopper grooves 4a on the rotating shafts 4. Alternately, the dislocation of the rotating shafts 4 can be prevented by restricting a movement of the stopper 13 in a longitudinal direction of the rotating shafts 4 by the handle base 6 or the operation handle 3 in such a state that the shaft locking pieces 11 are caused to lock on stepped portions which are formed by providing projecting portions on the rotating shafts 4.

In the event that the door handle apparatus is configured so that the shaft locking pieces 11 each have a hook shape which enables the shaft locking piece 11 to lock on the rotating shaft 4 detachably while being restricted from moving in the back direction, and that stopper holding portions 14 are provided on the handle base 6 which are adapted to restrict a rotation of the stopper 13 around the rotating shafts 4 which is caused by a dislocating force of the push button switch 10 in the back direction and to restrict a parallel movement of the stopper 13 in an opening direction of the shaft locking pieces, the assembling performance can be improved.

The shaft locking pieces 11 are formed to have the hook shape and are mounted on the rotating shafts 4 so as to be caught thereon. The shaft locking pieces 11 locking on the rotating shafts 4 have the shape which restricts the shaft locking pieces 11 from moving in the back direction relative to the rotating shafts 4, that is, the hook shape whose opening is directed to any other direction than the back direction. Even though a dislocating force applied to the push button switch 10 within the switch mounting hole 7 in the back direction is exerted on the stopper 13 and the shaft locking pieces 11 as a parallel motion generating force, there occurs no such case that the shaft locking pieces 11 are dislocated from the rotating shafts 4. The stopper holding portions 14 restrict a rotation of the stopper 13 around the rotating shafts 4 which is generated by the dislocating force applied to the push button switch 10 in the back direction so as to prevent the stopper piece 12 from being shifted outside of a dislocation preventive area of the push button switch 10. The stopper holding portions 14 also restrict a parallel movement of the stopper in the opening direction of the shaft locking pieces 11 so as to prevent the stopper 13 from being dislocated from the rotating shafts 4.

The stopper holding portions 14 can be realized by various approaches. For example, the stopper holding portions 14 are each made up of slits into which the stopper 13 is inserted when the stopper 13 is moved in parallel so as to receive the rotating shafts 4 in the hook-shaped openings of the shaft locking pieces 11 and which restrict a rotation of the stopper 13 around the rotating shafts 4 after the stopper 13 is so inserted and locking means which are caused to lock elastically on the stopper 13 as the stopper 13 moves in parallel so as to restrict a return movement.

In the event that the stopper holding portions are each made up of: a rotation restricting portion 15 for restricting a rotation angle of the stopper 13 around the rotating shaft 4 by exertion of a pushing operation force on the stopper piece 12 so as to cause the stopper piece 12 to stay in a position where the stopper piece 12 can close a moving path of the push button switch; and a movement restricting portion 16 for restricting a movement of the shaft locking portion 11 in an disengaging direction from the rotating shaft 4 when the stopper 13 rotates around the rotating shaft 4 from a posture resulting when the shaft locking piece 11 is operated to lock on the rotating shaft 4, since the stopper 13 can be held without requiring any particular elastic locking means , the construction of the door handle apparatus is made simple.

The door handle apparatus can be configured as having a construction in which in a sub-assembly state in which the operation handle 3 is connected to the handle base 6 and the push button switch 10 is mounted on the base handle 3, the looseness of the individual components or in particular, the looseness of the pushbutton switch 10 is prevented completely or a construction in which the looseness of the individual components is prevented completely when the mounting operation of the door handle apparatus on the door is completed without the individual components being separated abruptly from each other in the sub-assembly state.

In the event that a configuration is adopted in which the dislocation of the individual components is mainly restricted in the sub-assembly state and the individual components are restrained from moving when the door handle apparatus is fixed to the door 5, so that the looseness and separation of the individual components are prevented finally, the assembling process of the sub-assembly can be made simple, thereby making it possible to reduce the number of man-hours required in assembling the components involved. The door handle apparatus in which the individual components are finally restrained in such a state that the door handle apparatus is mounted on the door 5 has a synthetic resin sheet member which is connected to the handle base so as to be interposed between the door and the stopper piece of the stopper, so that when the door handle apparatus is mounted on the door, the push button switch can be brought into press contact with the retaining step portion via the sheet member so as to restrict looseness of the push button switch.

The sub-assembly state which is realized without using any securing elements can be realized mainly by mounting sequentially the other components so as to close the moving path along which the assembled components can be disassembled in case it is so closed. However, in the event that all the components involved are formed of rigid materials, since it is difficult to restrict a movement of a component that is mounted last in a dislocating direction, it is not possible to prevent the separation of the components involved completely.

To deal with the problem above, by mounting the sheet member having appropriate flexibility in a final step of the assembling operation by making use of elasticity, the movement of the individual components can be restricted completely. Thus, the separation of the components involved can be restricted completely.

According to one or more embodiments of the invention, the number of man-hours required to mount the door handle apparatus on to the door can be reduced, and the assembling performance of the components involved can be improved.

Other aspects and advantages of the invention will be apparent from the following description, the drawings and the claims.

### BRIEF DESCRIPTION OF DRAWINGS

FIG. 1(a) is a front view of a door handle apparatus of an exemplary embodiment of the invention, and FIG. 1(b) is a back view of the door handle apparatus.

FIG. 2(a) is a sectional view taken along the line 2A-2A in FIG. 1(a), FIG. 2(b) is a sectional view taken along the line 2B-2B in FIG. 2(a), FIG. 2(c) is a sectional view taken along the line 2C-2C in FIG. 1(a), and FIG. 2(d) is a sectional view taken along the line 2D-2D in FIG. 1(a).

FIG. 3 is an exploded view of a main part of FIG. 1.

FIG. 4 is a sectional view of FIG. 3.

FIG. 5(a) is a sectional view taken along the line 5A in FIG. 3 which shows an initial step of an assembling process of the stopper, FIG. 5(b) is a sectional view taken along the line 5B in FIG. 3 which is in the same step as FIG. 5(a), FIG. 5(c) is a sectional view corresponding to FIG. 5(a) which shows a state resulting after the stopper is mounted accordingly, FIG. 5(d) is a sectional view corresponding to FIG. 5(b) which shows a state in the same step as FIG. 5(c), and FIG. 5(e) is a sectional view showing a state in which a parallel movement of the stopper is restricted.

FIGS. 6(a) to 6(d) are explanatory drawings depicting how to restrict the movement of the stopper, FIG. 6(a) is a sectional view corresponding to FIG. 5(c) which shows a function of a rotation restricting portion, FIG. 6(b) is a sectional view corresponding to FIG. 5(d) which shows a state in the same step as FIG. 6(a), FIG. 6(c) is a sectional view showing a function of a stopper restricting portion, and FIG. 6(d) is a sectional view showing a function of a sheet member.

### DESCRIPTION OF EMBODIMENTS

An exemplary embodiment of the invention is described in reference to drawings.

A door handle apparatus is formed by connecting an operation handle 3 including a handle portion 1 to a handle base 6 so as to rotate around rotating shafts 4 and is fixed to a front surface of a door 5 of a vehicle.

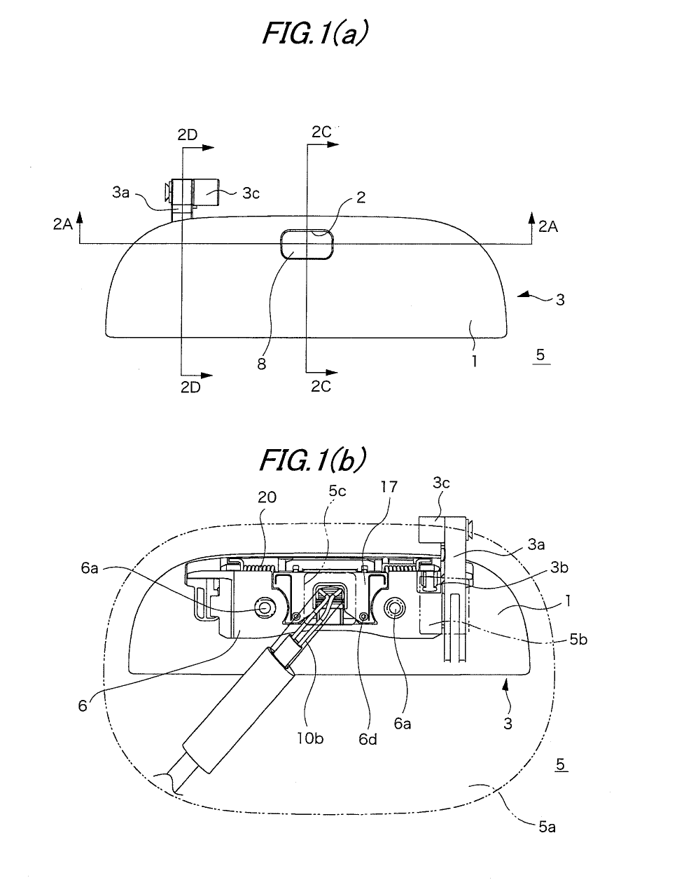

The handle base 6 is formed to have such a size that the handle base 6 is completely concealed by the operation handle 3 when viewed from a front of the door handle apparatus as is shown in FIG. 1(a) so as to meet such a request from the viewpoint of design that only the operation handle 3 can appear on the front surface of the door 5. This door handle apparatus is fixed to the door 5 in a posture shown in FIG. 1(a) by making use of studs 6a which are provided on the handle base 6 so as to project therefrom. A depression-like recess portion 5a is formed on a door panel (the door 5) so as to prevent the operation handle 3 from projecting from a general surface of the door 5.

An arm 3a is provided on a back of the operation handle 3 so as to project therefrom. In such a state that the door handle apparatus is fixed to the door 5, the arm 3a is inserted into an interior of the door 5 from an arm insertion opening 5b opened in the door panel 5 and is connected to a door lock device, not shown, in the interior of the door 5. When the handle portion 1 is rotated vertically so as to be pulled out upwards from an initial rotating position shown in FIG. 1(a) to an operating rotating position, an operating force exerted on the handle portion 1 is transmitted to the door lock device via a rod, not shown, which is connected to a holder 3b, whereby the door 5 can be operated to open.

A counterweight 3c is fixed to a distal end of the arm 3a for canceling an operating force which is generated to attempt to open the door 5 by an inertia force generated, in turn, at the time of side impact.

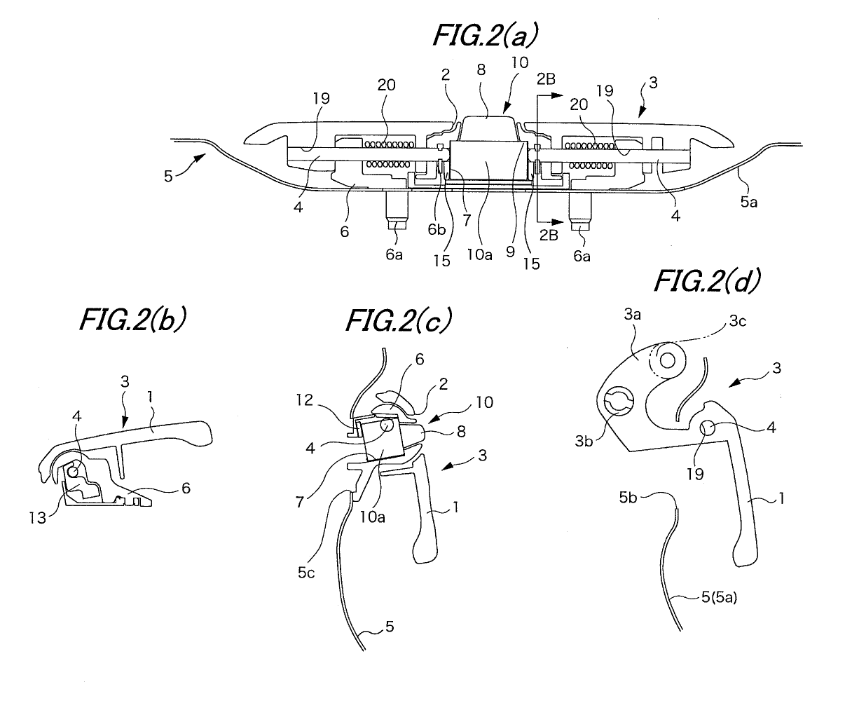

As is shown in FIG. 2(a), as to the rotating shafts 4 for connecting the operation handle 3 to the handle base 6, two rotating shafts 4 are disposed on left- and right-hand sides of a push button switch 10, which will be described later, so as to hold the push button switch 10 therebetween. Each rotating shaft 4 extends through shaft insertion holes 19 opened in the operation handle 3 and the handle base 6 to come into abutment with a side wall of a case 10a of the push button switch 10. A torsion spring 20 is placed around each rotating shaft 4 so as to bias the operation handle 3 to the initial rotating position side.

A switch mounting hole 7 is opened in a left-right central position of the handle base 6, so that the push button switch 10 is fixed therein. In this embodiment, the push button switch 10 is used as a requesting signal generation switch for urging a portable device carried by a user to output an ID signal.

The push button switch 10 is formed so that an operation button portion 8 projects from a front surface of the case 10a, and a wiring harness 10b is pulled out of a back of the case. A wiring harness insertion hole 5c is opened in the door panel 5 so that the wiring harness 10b is pulled into the interior of the door panel 5.

The push button switch 10 is inserted into the switch mounting hole 7 from a back side opening portion thereof with the operation button portion 8 at the front of the push button switch 10 and is then prevented from being dislocated by a stopper 13, which will be described later. In order to prevent a forward dislocation of the pushbutton switch 10, a retaining step portion 9 is formed on an inner wall of the switch mounting hole 7 so as to be brought into abutment with a front wall of the case 10a of the push button switch 10. Further, a button insertion opening 2 is opened in the handle portion 1 of the operation handle 3 so that the operation button portion 8 of the push button switch 10 is exposed when the operation handle 3 is in its initial rotating position.

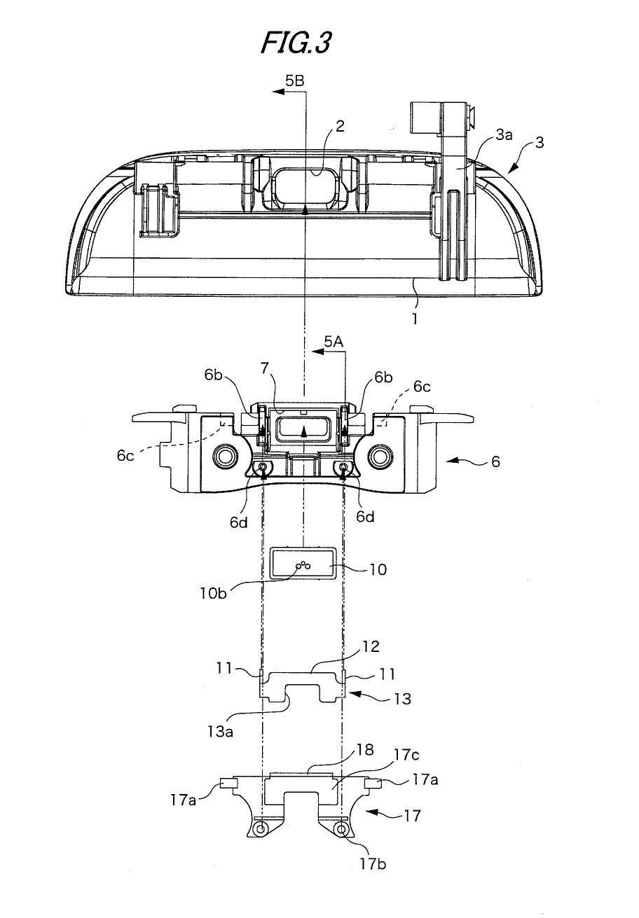

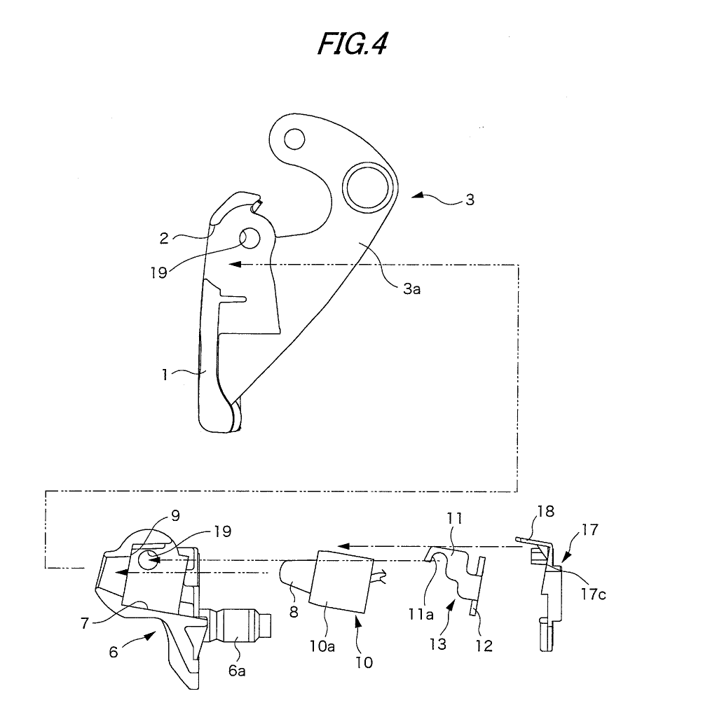

As is shown in FIGS. 3 and 4, the stopper 13 is formed of a metallic plate material and includes shaft locking pieces 11 which are bent in the front direction from both side edges of a stopper piece 12. The stopper piece 12 has a rectangular shape having such a size that the stopper piece 12 can press against almost a whole surface of a back wall of the case 10a of the push button switch 10, and a wiring harness passing recess portion 13a is cut out at a central portion of the stopper piece 12 with an opening of the recess portion 13a oriented downwards.

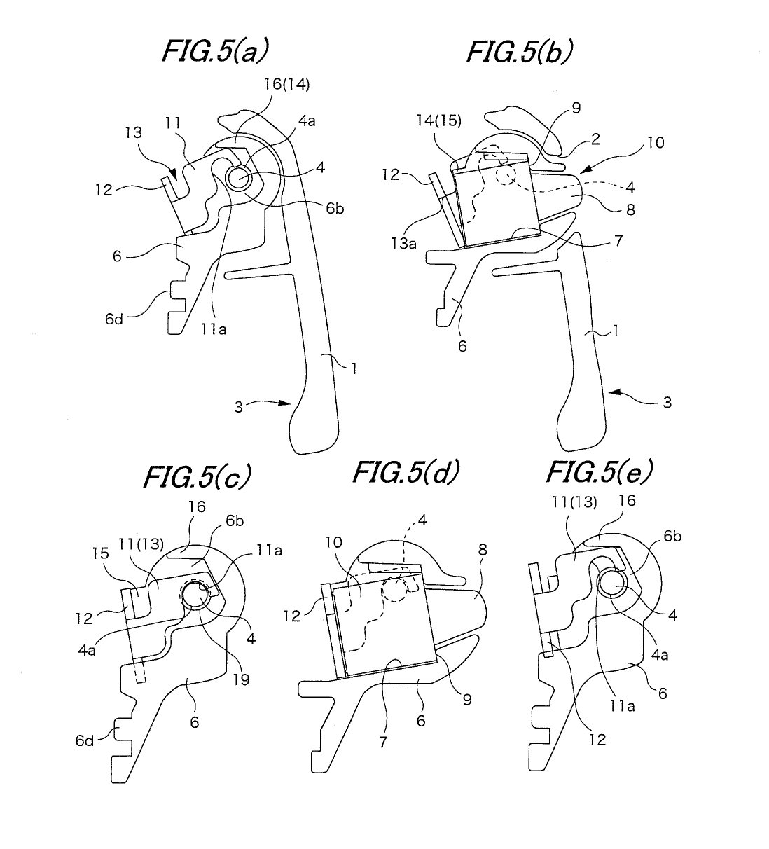

As is shown in FIG. 5(a), the shaft locking piece 11 has a hook shape in which a U-shaped fitting cutout 11a is provided with its opening oriented downwards, and the U-shaped fitting cutout 11a has a bottom portion whose diameter is slightly large than an outside diameter of a stopper groove 4a formed on the rotating shaft 4 but is smaller than a general diameter of the rotating shaft 4.

On the other hand, stopper insertion grooves 6b are formed on the handle base 6 with their openings oriented in the back direction so that the shaft locking pieces 11 of the stopper 13 are fitted therein. The stopper insertion grooves 6b are disposed left and right so as to hold the switch mounting hole 7 therebetween, and the rotating shaft 4 extends through its corresponding stopper insertion groove 6b. A movement restricting portion 16, which has a shape like eaves, is formed on each stopper insertion groove 6b.

In mounting the stopper 13 which is configured in the way described above, firstly, as is shown in FIGS. 5(a) and 5(b), with the rotating shafts 4 inserted into the stopper 13, the stopper 13 is inserted so that hook distal end portions of the shaft locking pieces 11 are inserted into gaps defined between the rotating shafts 4 and the movement restricting portions 16. Thereafter, the fitting cutouts 11a can easily be fitted in the stopper grooves 4a, as is shown in FIG. 5(b), by inserting the hook distal end portions of the shaft locking pieces 11 into the gaps with the stopper 13 inclined until an interference between the stopper piece 12 and a bottom wall of the case 10a of the push button switch 10 is produced and then, releasing the inclination of the stopper 13 so that the interference position is shifted upwards (refer to FIGS. 5(c), 5(d)).

Stopper holding portions 14 are formed on the handle base 6 so that states shown in FIGS. 5(c), 5(d) are maintained without using machine screws or the like and that an easy dislocation of the stopper 13 from the rotating shafts 4 is prevented, and the stopper holding portions 14 are each made up of the movement restricting portion 16 and a rotation restricting portion 15 which is formed on each side wall of the switch mounting hole 7.

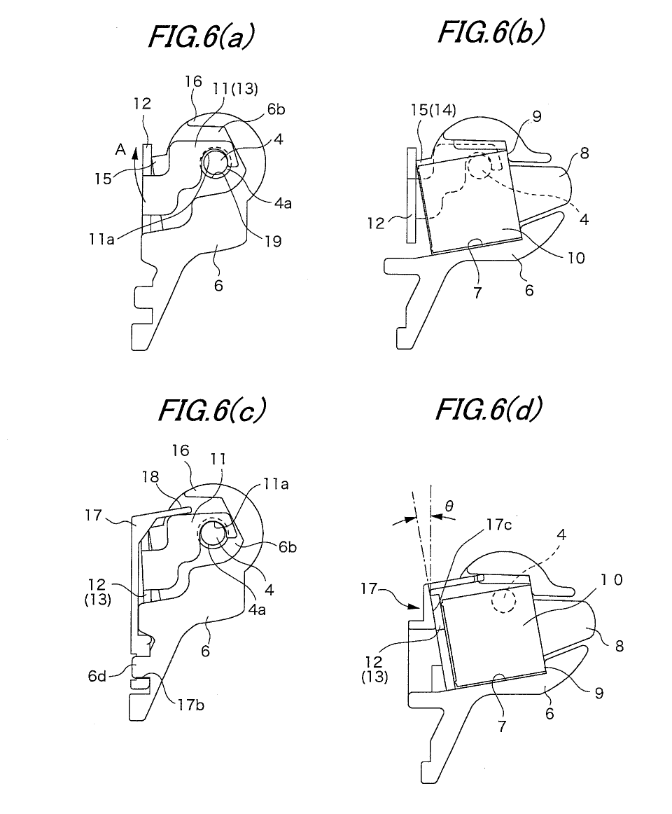

As is shown in FIG. 5(e), the movement restricting portion 16 restricts a parallel upward movement of the stopper 13, so as to prevent a disengagement of the fitting cutout 11a from the rotating shaft 4 which would otherwise be triggered by the movement of the stopper 13 in such a direction. The rotation restricting portion 15 restricts a rotation of the stopper 13 which will be generated when a load is applied to the push button switch 10 in the back direction as by pulling the wiring harness with the push button switch 10 mounted in place. In the event that the load is applied to the push button switch 10 in the back direction, a clockwise rotational moment (indicated by an arrow A) is generated in the stopper 13, as is shown in FIGS. 6(a) and 6(b), there is caused a fear that the stopper piece 12 is withdrawn from the interfering position with the bottom wall of the push button switch 10, resulting in a fall of the push button switch 10 from the handle base 6. As is shown in FIG. 6(b), the rotation restricting portions 15 control the rotation angle of the stopper 13 to such an extent that the restriction imposed on the push button switch 10 by the stopper piece 12 is not affected.

Thus, since the stopper 13 is dislocated in no way once the stopper 13 is mounted as long as predetermined rotation and parallel movement are not produced, there is no risk that the stopper 13 is abruptly dislocated from the rotating shafts 4 while the components involved are stored in the form of sub-assemblies. Because of this, the necessity of machine screws or the like is obviated when components involved are assembled into a sub-assembly, thereby the assembling performance being improved.

In this embodiment, the door handle apparatus has a synthetic resin sheet member 17. The sheet member 17 is interposed between the stopper 13 and the door panel 5 when the door handle apparatus is fixed to the door 5, so as to prevent corrosion that would be produced by a direct contact between the stopper 13, which is formed of the metallic plate material, and the door panel 5.

As is shown in FIG. 3, seat mounting slits 6c and press fitting bosses 6d are provided on the base handle 6 so that the sheet member 17 is mounted thereon, while insertion pieces 17a and press fitting holes 17b are formed on the sheet member 17. The seat mounting slits 6c are opened at upper end edges of the handle base 6 so as to open upwards. The sheet member 17 is mounted on the handle base 6 by, firstly, inserting the insertion pieces 17a into the seat mounting slits 6c from thereabove and thereafter, press fitting the press fitting bosses 6d in the press fitting holes 17b by making use of the elasticity of the sheet member 17. Once the sheet member 17 is mounted on the handle base 6, movements of the insertion pieces 17a in the back direction are restricted by the seat mounting slits 6c, whereby an easy dislocation of the sheet member 17 from the handle base 6 is prevented. Although FIG. 3 shows back views of the individual components involved, for the sake of easy understanding, only the sheet member 17 is shown in a front view.

As is shown in FIGS. 3, 4, a stopper restricting portion 18 is provided at an upper edge of the sheet member 17 so as to project towards the front side, and further, a stopper 13 fastening surface 17c is formed at a proximal end portion of the stopper restricting portion 18. As is shown in FIG. 6(c), with the sheet member 17 mounted on the handle base 6, the stopper restricting portion 18 comes into interference with the shaft locking pieces 11 of the stopper 13 so as to restrict both a rotation of the stopper 13 in the direction shown in FIG. 6(a) and a parallel movement shown in FIG. 5(e). Since the locking release path which releases the locking of the stopper 13 with the rotating shafts 4 is closed completely in this way by mounting the sheet member 17 on the handle base 6, the dislocation of the stopper 13 and the push button switch 10 from the handle base 6 is prevented completely while the sub-assembly is assembled on to the door 5 or such sub-assemblies are stored or transported.

As is shown in FIG. 6(d), with the sheet member 17 mounted on the handle base 6, the stopper fastening surface 17c supports movably a back of the stopper piece 12. Since the stopper fastening surface 17c is inclined at an appropriate angle (θ) relative to a line in a vehicle high direction, the stopper piece 12 receives a compression force from the stopper fastening surface 17c as the door handle apparatus is fixed to the door 5. As a result of this, the stopper 13 receives the force in the vehicle width direction, as well as a force in the vehicle height direction which results as a component of the force, whereby appropriate portions of the stopper 13 are brought into press contact with each other to move to such a position where no looseness is allowed, and thereafter, any movement is restricted completely. Thus, any looseness is prevented completely that would otherwise occur while the vehicle is running.

### INDUSTRIAL APPLICABILITY

The present invention is applicable to a door handle.

### DESCRIPTION OF REFERENCE NUMERALS AND SIGNS

1 handle portion
2 button insertion opening
3 operation handle
4 rotating shaft
5 door
6 handle base
7 switch mounting hole
8 operation button
9 retaining step portion
10 push button switch
11 shaft locking portion
12 stopper
13 stopper
14 stopper holding portion
15 rotation restricting portion
16 movement restricting portion
17 sheet member
18 stopper restricting portion.

1. A door handle apparatus comprising:
a handle base;
an operation handle rotatably connected to the handle base via a rotating shaft and including a handle portion on which a button insertion opening is opened;
a switch mounting hole opened in the handle base ;
a push button switch inserted from a back side opening portion of the switch mounting hole and including an operation button portion exposed from a front side opening portion of the switch mounting hole;
a retaining step portion formed within the switch mounting hole and adapted to prevent the push button switch from dislocating in a front direction; and
a stopper including a shaft locking piece engaging with the rotating shaft to restrict a dislocation of the rotating shaft, and a stopper piece for restricting a dislocation of the push button switch in a back direction.

2. The door handle apparatus according to claim 1, wherein the shaft locking piece has a hook shape which is restricted from moving in the back direction and engaged with the rotating shaft ;
a stopper holding portion is provided on the handle base and adopted to restrict a rotation of the stopper around the rotating shaft which is caused by a dislocating force of the push button switch in the back direction and to restrict a movement of the stopper in an upper direction.

3. The door handle apparatus according to claim 2, wherein the stopper holding portion includes:
a rotation restricting portion for restricting a rotation angle of the stopper around the rotating shaft by exertion of a pushing operation force on the stopper piece so as to cause the stopper piece to stay in a position where the stopper piece can close a moving path of the push button switch; and
a movement restricting portion for restricting the shaft locking portion from moving in a disengaging direction from the rotating shaft when the stopper rotates around the rotating shaft from a posture when the shaft locking piece is operated to be engaged with the rotating shaft .

4. The door handle apparatus according to claim 1, wherein the handle base is fixed on a door of a vehicle,
the door handle apparatus further comprising:
a synthetic resin sheet member which is connected to the handle base and interposed between the door and the stopper piece,
wherein the push button switch is pressed to the retaining step portion by the sheet member so as to restrict looseness of the push button switch.

5. The door handle apparatus according to claim 4, wherein the sheet member includes a stopper restricting portion adapted to restrict a movement of the stopper in a direction in which an engagement of the stopper with the rotating shaft is released.
